(19) United States
(12) Patent Application Publication
(10) Pub. No.: US 2008/0267690 A1
(43) Pub. Date: Oct. 30, 2008

(54) Study Paddle

(76) Inventors: Juan Carlos Unda, Whittier, CA (US); Miguel Angel UndaLuquin, Whittier, CA (US)

Correspondence Address: WILSON DANIEL SWAYZE, JR., 3804 CLEARWATER CT., PLANO, TX, 75025, US

(21) Appl. No.: 11/741,201

(22) Filed: Apr. 27, 2007

(51) Int. Cl. B42F 13/40

(52) U.S. Cl. 402/4

(57) ABSTRACT

A study paddle for mounting removable sheets that can be easily shown to a user includes a handle to allow the user to hold the study paddle, a mounting member for mounting the removable sheets having a front side and back side, and a first split ring to accept the removable sheets. The first split ring moves between an open position and a closed position and the removable sheets travel on the first split ring to be moved between the front side and back side. The study paddle includes a second split ring, and the mounting member includes a substantially flat front surface. The first split ring includes a first member for rotating with respect to a second member; the first split ring includes an end face, the first member includes a male connector and the second member includes a female connector. The first member rotates on a shaft.

### FIELD OF THE INVENTION

This invention relates to a device useful in assisting children and adults to play games or to assist in presenting study materials, more particularly, the present invention relates to a study paddle which includes removable sheets which includes indicia for the game or the study material and which includes a device to permit the sheets to be individually rotated so that the next sheet can be quickly and conveniently presented on the study paddle.

### BACKGROUND ART

Ring binders are known and are in great use in various fields of endeavor. Students use them at all levels of education, businesses use them to store information, and provide for readily changeable information. Other educational sources use them to provide books or other materials which can be easily updated by merely changing the loose leaf sheets within the ring binder. Binders of the split ring type are extensively used to carry heavy page loads of cummulative reference materials. The rings commonly reach a diameter of three inches and carry such a weight as to severely stress the prongs, the actuating mechanism and the binder covers as well.

In the case of reference materials, many companies utilize binder mechanisms in order to allow the materials to be updated with the incorporation of new, replacement, or supplemental pages. This allows the reference material to be kept current over an extended period of time without replacing in mass an entire volume. Reference materials held by ring binders are often difficult to photocopy, and persons desiring a photocopy will often remove portions from the ring binder temporarily to facilitate photocopying. A binding mechanism must also be able to maintain the binding rings in a tightly closed position during normal use.

Such ring binders have long been known in the art and have a wide variety of uses. However, such ring binders are not convenient to present the loose leaf sheets to another user.

### SUMMARY

This invention pertains to improvements over the loose leaf binders. The invention provides a simple, economically produced dependable mechanism of the split ring variety affording among other advantages, a study paddle which includes a split ring member.

A study paddle for mounting removable sheets that can be easily shown to a user includes a handle to allow the user to hold the study paddle, a mounting member for mounting the removable sheets having a front side and back side, and a first split ring to accept the removable sheets.

The first split ring moves between an open position and a closed position and the removable sheets travel on the first split ring to be moved between the front side and back side.

The study paddle includes a second split ring, and the mounting member includes a substantially flat front surface.

The first split ring includes a first member for rotating with respect to a second member; the first split ring includes an end face, the first member includes a male connector and the second member includes a female connector.

The first member rotates on a shaft.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a perspective view of the study paddle of the present invention;

FIG. 2 illustrates a view of the removable sheets of the present invention;

FIG. 3 illustrates an end view of the study paddle of the present invention;

FIG. 4 illustrates a side view of the study paddle of the present invention;

FIG. 5 illustrates a perspective view of the split rings of the present invention.

### DETAILED DESCRIPTION

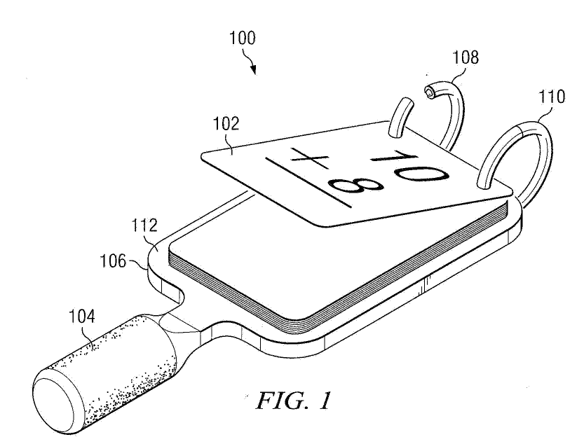

Turning to FIG. 1, a study paddle 100 is illustrated and includes a handle 104 for allowing the study paddle 100 to be held at a convenient position so that other users can see and respond to the removable sheets 102 which are mounted on the first split ring 108 and the second split ring 110. The study paddle 100 additionally includes a mounting member 106 which is shown as having a substantially flat front surface 112 which could be in the form of a rectangular, a circle, a trapezoidal, an oval or any other suitable shape. The front surface 112 of the mounting member 106 allows for a plurality of removable sheets 102 to be sequentially presented to users of the study paddle 100. The removable sheets 102 travel on the first split ring 108 and the second split ring 110 so that the removable sheets 102 can be placed on the back surface of the mounting member 106 to allow another removable sheet 102 to be presented to the users.

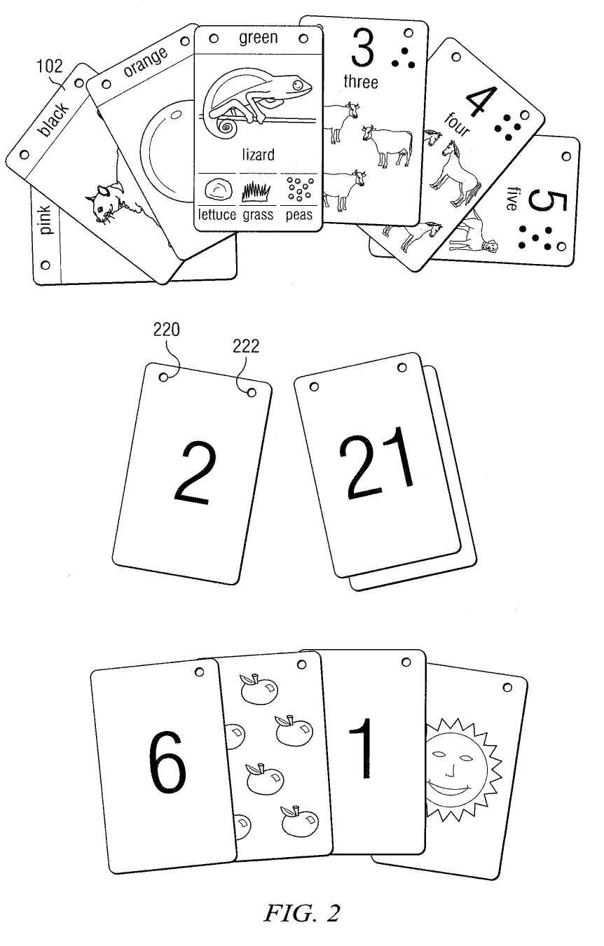

FIG. 2 illustrates a plurality of removable sheets 102 having indicia which shows animals, numbers, and plants and other suitable objects. The removable sheets 102 include a first aperture 220 and a second aperture 222 to cooperate with the first split ring 108 and the second split ring 110.

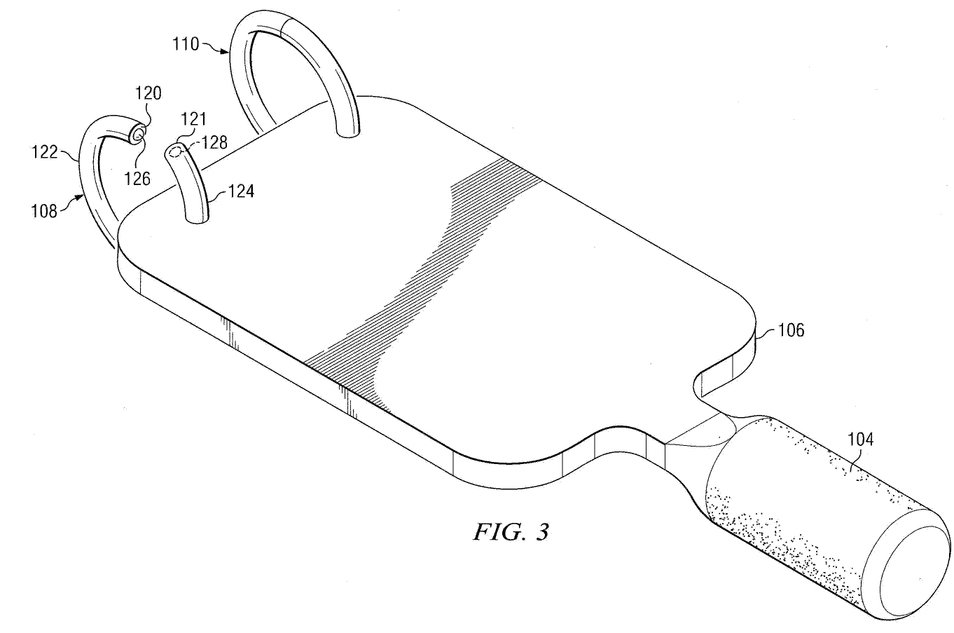

FIG. 3 illustrates a perspective view of the study paddle 100. More particularly, FIG. 3 illustrates the handle 104 connected to the mounting member 106.

FIG. 3 additionally illustrates that the first split ring 108 is the open position to accept the removable sheets 102 and the second split ring 110 is in the closed position to allow the removable sheets 102 to travel. The first split ring 108 includes an end face 120 positioned on one end of the first member 122 of the first split ring 108 to cooperate with an opposing end face 121 of a second member 124 of the first split ring 108 when the first split ring 108 is closed.

FIG. 3 additionally illustrates a sphere male connector 126 which is in the shape of a semi sphere to connect with the female connector 128.

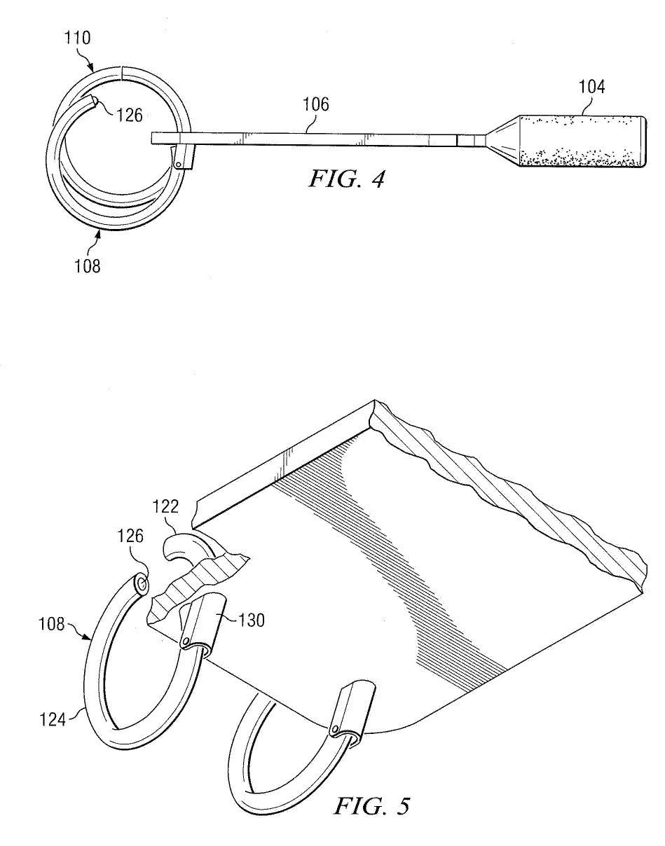

FIG. 4 illustrates a side view of the study paddle 100 of the present invention including the handle 104, the mounting member 106 and the spherical male connector 126.

FIG. 5 illustrates a detail of the first split ring 108 including the first member 122 which has been placed in a open position to accept the removable sheets 102 and which is angled with respect to the second member 124 as a result of being rotated on the shaft 130 which is connected to a pair of arms of the second member 124. The first split ring 108 rotates to a closed position on the shaft 130.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. A study paddle for mounting removable sheets that can be easily shown to a user, comprising:
a handle to allow the user to hold the study paddle;
a mounting member for mounting the removable sheets having a front side and back side;
a first split ring to accept the sheets;
wherein said first split ring moves between an open position and the closed position and the removable sheets travel on the first split ring to be moved between the front side and back side.

2. A study paddle for mounting removable sheets that can be easily shown to a user as in claim 1, wherein said study paddle includes a second split ring.

3. A study paddle for mounting removable sheets that can be easily shown to a user as in claim 1, wherein the mounting member includes a substantially flat front surface.

4. A study paddle for mounting removable sheets that can be easily shown to a user as in claim 1, wherein said first split ring includes a first member for rotating with respect to a second member

5. A study paddle for mounting removable sheets that can be easily shown to a user as in claim 1, wherein said first split ring includes an end face.

6. As in claim 4, wherein the first member includes a male connector and the second member includes a female connector.

7. A study paddle for mounting removable sheets that can be easily shown to a user as in claim 4, wherein said first member rotates on a shaft.
